(19) United States
(12) Patent Application Publication
(10) Pub. No.: US 2005/0001206 A1
(43) Pub. Date: Jan. 6, 2005

(54) Permanently-suspended bactericidal conductive minerals in solution

(76) Inventors: William Ray Blessing, Houston, TX (US); Carolyn Ruth Blessing, Houston, TX (US)

Correspondence Address: WILLIAM RAY BLESSING, SR., 10846 VILLAGE TRAIL DR., HOUSTON, TX, 77065, US

(21) Appl. No.: 10/419,636

(22) Filed: Apr. 22, 2003

(51) Int. Cl. C09D 5/14; C04B 14/00; H01C 1/00

(52) U.S. Cl. 252/500; 106/15.05; 106/401

(57) ABSTRACT

Bactericidal minerals (preferably Silver) are permanently suspended in a specific treated solution. Flow transfer chambers within a specific reactor direct the incoming solution through an electromechanical device which activates the mineral, causing it to bond with the specific treated solution, producing an unalterable, permanently-suspended, bactericidal, antiretroviral solution having particles at the atomic level with capability of penetrating red cell membranes without causing cellular damage.

### BACKGROUND OF THE INVENTION

The disclosed invention relates to the field of colloidal solutions and particularly in the area of minerals. With the present industry, colloidal solutions only have a limited shelf life, a matter of days. What is needed is permanently-suspended minerals. Accordingly, it is the object of the disclosed invention to provide a solution of minerals which are suspended in solutions indefinitely. It is another object of said invention to provide a useful end product, specifically in the area of medicine, for disease prevention and cures.

### BRIEF SUMMARY OF INVENTION

The disclosed invention is an improvement over prior practice because this product is not a colloid. In the appropriate circumstances, permanent suspension of conductive minerals in solution can be effectively and efficiently achieved. This is accomplished by providing an electromechanical device capable of a plurality of required tasks and control settings, producing different types and strengths of end product.

### BRIEF DESCRIPTION OF DRAWINGS

FIGS. 1, 2, 3, 4 and 5 are pictorial representations showing the preferred embodiment of the disclosed invention.

FIG. 1 illustrates a natural water molecule.

FIG. 2 illustrates the water molecule being altered by a specific controlled electrical impulse.

FIG. 3 illustrates the plurality of Oxygen atoms now free to be fused.

FIG. 4 illustrates Silver atoms now free to be fused.

FIG. 5 illustrates one Silver atom bonded by covalent fusion with a multitude of Oxygen atoms.

### DETAILED DESCRIPTION OF THE PREFERRED EMBODIMENT

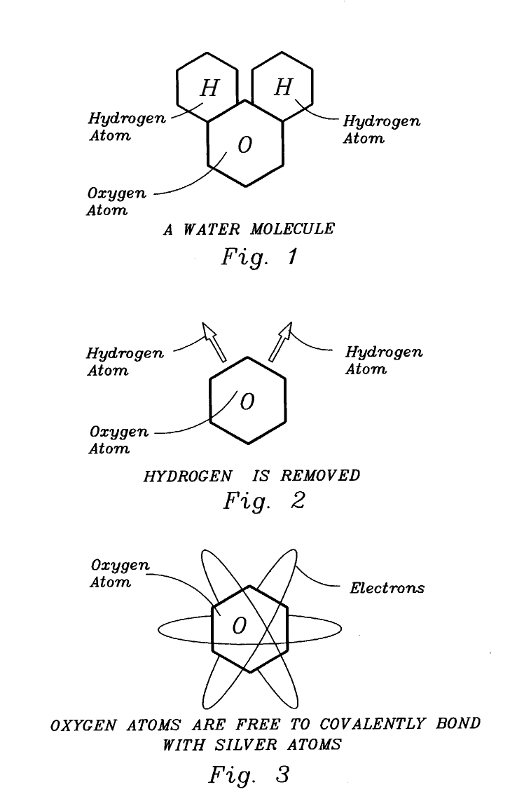

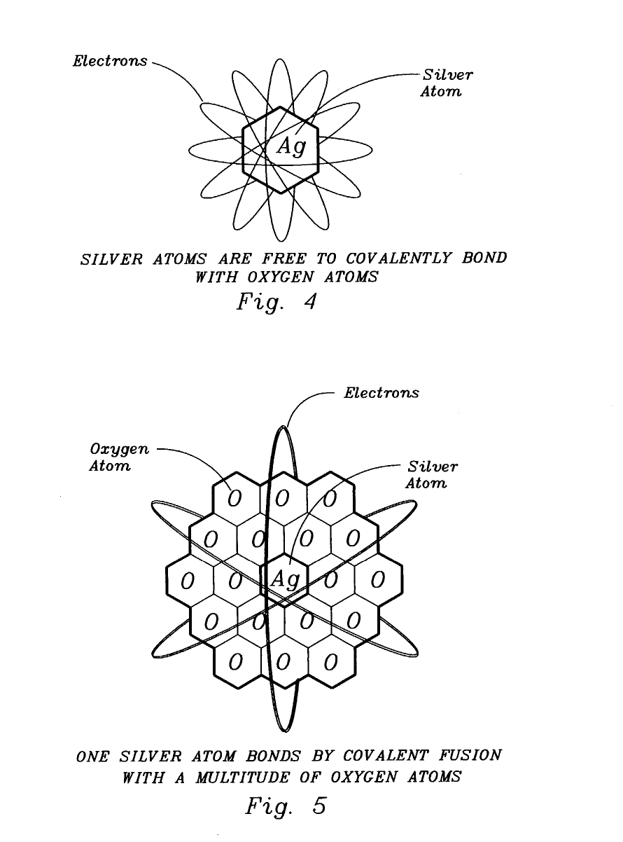

As shown in FIGS. 1, 2, 3, 4, and 5 of the preferred embodiment, the invention, an electro-transformation of a molecule of water, (FIG. 1), Hydrogen is separated from Oxygen, causing molecular change; (FIG. 2), the Hydrogen atom dissipates; (FIG. 3), the Oxygen atom is then free for covalent fusion to occur with the Silver or any conductive mineral; (FIG. 4), Silver atoms are free to covalently bond with Oxygen atoms, and finally, (FIG. 5) covalent fusion occurs between a single Silver atom and a plurality of Oxygen atoms, rendering a permanently-suspended, bactericidal solution.

In operation, the invention may be developed by using any conductive mineral and many different types of solutions with variable densities. The flow control device has a large range of settings, permitting a light mixture as well as a heavy concentrate of the permanently-suspended solution which can then be delivered by means of a gravity-flow system or a pressure-controlled system.

1. Said invention is a permanently-suspended mineral in solution.

2. Said invention is a multitude of Oxygen atoms arranged symmetrically about the center of a charged Silver atom.

3. Said invention cannot be altered or transformed.

4. Said invention cannot be combined with any other substance to form a compound.

5. Said invention is capable of being atomically absorbed into matter.
